(19) United States
(12) Patent Application Publication
(10) Pub. No.: US 2006/0174125 A1
(43) Pub. Date: Aug. 3, 2006

(54) Multiple cryptographic key security device

(76) Inventor: George M. Brookner, Norwalk, CT (US)

Correspondence Address: PERMAN & GREEN, 425 POST ROAD, FAIRFIELD, CT, 06824, US

(21) Appl. No.: 11/047,230

(22) Filed: Jan. 31, 2005

(51) Int. Cl. H04L 9/00

(52) U.S. Cl. 713/176; 713/155

(57) ABSTRACT

A security domain for controlling PKI keys includes a root certificate authority, and one or more regional certificate authorities, each having a remote control and a postal security device. Different PKI keys are utilized to sign and to validate the authenticity of a digital signature for each certificate authority.

### BACKGROUND

The disclosed embodiments are related developing different PKI keys for different purposes, those different keys being generated from different seeding random parameters.

Brief Description of Related Developments

Typical of devices that protect critical information exchanged between themselves and external sources or within their secure boundary, Public Key Infrastructure (PKI) is the most secure set of standards to protect said information against fraudulent attacks to compromise or steal the information. Cryptographic keys are generated of some fixed bit length or variable bit lengths.

For example, International Application PCT/US01/45765 discloses a postal security device having variable length cryptographic keys. The length of the key may be equated with the strength of the supporting mathematics against attempts to break the coding and recover the information protected by the PKI. Generally, reduced key lengths may be considered to protect information of a non-catastrophic nature (if said information is disclosed). Information, as financial, legal or the like would, in contrast, utilize an extended key length to protect the related information from disclosure or tampering. Public/Private key pairs are necessary to secure and validate the information exchanges with which they are related. Information is signed by the Private Key of the generator and validated by the generator's Public Key held by the receiver.

The weak point with existing art is that the source for the creating of PKI keys is from one source of seeding (random number) information.

### SUMMARY OF THE EXEMPLARY EMBODIMENTS

The exemplary embodiments are directed to a security domain for controlling PKI keys that includes a root certificate authority, and one or more regional certificate authorities, each having a remote control and a postal security device. Different PKI keys are utilized to sign and to validate the authenticity of a digital signature for each certificate authority.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention.

### DETAILED DESCRIPTION OF THE EXEMPLARY EMBODIMENTS

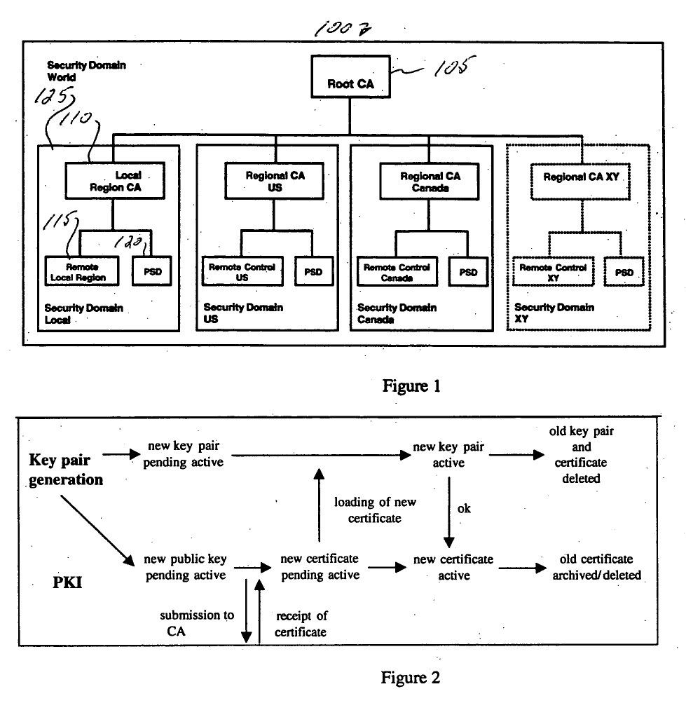

FIG. 1 shows a block diagram of a security domain 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

The security domain 100 of FIG. 1 includes a root certificate authority (Root CA) 105 and a number of regional certificate authorities 110. Within each regional certificate authority there may be a remote control 115 and a postal security device (PSD) 120.

The security domain 100 may operate to utilize its own specific cryptographic domain parameters. A transition between different security domains is not possible without consent of the Root Certificate Authority (CA). A security domain may represent a country, a geographical region, a local entity. All certificates used within a specific security domain can be managed “locally” by the Regional CA without having to gain access to the Root CA. A security device, hereafter referred to as PSD (privacy security device) always belongs to exactly one security domain. The top entity of a security domain is always a CA. There may exist one world-wide security domain with the Root CA at its top and (several) subordinate security domains each with a CA at its top.

The Root CA 105 generally operates to sign different region certificates with signatures derived from different initial parameter sets. The Root CA 105 represents the highest cryptographic authority of the disclosed PKI world-wide. Its main function is to issue all certificates of the next lower level of the PKI chain, i.e. the Regional CA certificates 110.

The Regional CAs 110 represent the highest dedicated cryptographic authority for a particular region 125 and operates as the certificate authority for other sub-Region PKI entities and the associated PSD's 120. The Regional CAs 110 also issue all Remote Control certificates and all PSD Authentication certificates.

The remote controls 115 establish a secure communication channel to the PSDs 120 to carry out various administrative operations.

According to the disclosed embodiments different PKI keys are utilized to sign and to validate authenticity of a digital signature. The Root CA 105 and each regional CA 110 may provide different key pairs, generated from different parameter sets to sign and authenticate signatures. The disclosed embodiments utilize a public key certificate hierarchy disposed to support various and independent secure entities, where each entity is protected from access by all other entities, and yet part of the overall security infrastructure of the implemented PKI. The disclosed embodiments provide multiple of PKI key pair generations of any selected length, those keys each being generated by distinct seeding parameters.

Cryptographic keys and certificates used within PKJ, herein, as well as by PSDs, follow a strict life cycle. The keys must always be in one of the three possible states: pending active, active or inactive. The specifics of the transitions from one state to another are different depending of the specific keys and certificates considered. The transitions from one state to an other are triggered by specific operations as depicted in FIG. 2.

After its generation, a key pair is always in the pending active state first. Only one key pair and the corresponding certificate can be active in the generating device at a time.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A security domain for controlling PKI keys comprising:
a root certificate authority; and
one or more regional certificate authorities, each having a remote control and a postal security device, wherein different PKI keys are utilized to sign and to validate the authenticity of a digital signature for each certificate authority.

2. The security domain for controlling PKI keys of claim 1, wherein the one or more regional certificate authorities issue remote control certificates and postal security device authentication certificates.

3. The security domain for controlling PKI keys of claim 1, wherein one or more certificates used within the security domain can be managed locally.

4. The security domain for controlling PKI keys of claim 1, wherein the postal security device belongs to one security domain.

5. The security domain for controlling PKI keys of claim 1, wherein the root certificate authority operates to sign one or more region certificates with signatures derived from one or more parameter sets.

6. The security domain for controlling PKI keys of claim 1, wherein the remote control establishes secure communications with the postal security device.

7. The security domain for controlling PKI keys of claim 1, wherein the root certificate authority and each of the one or more regional certificate authorities provides different key pairs.

8. The security domain for controlling PKI keys of claim 7, wherein the different key pairs are generated from different parameter sets.

9. The security domain for controlling PKI keys of claim 1, wherein the PKI keys are in one of a pending active state, an active state or an inactive state.

10. The security domain for controlling PKI keys of claim 1, wherein certificates generated by the root certificate authority or the one or more regional certificate authorities are in one of a pending active state, an active state or an inactive state.

11. The security domain for controlling PKI keys of claim 1, wherein the PKI Keys are of different lengths.

12. The security domain for controlling PKI keys of claim 1, wherein each of the PKI keys are generated by distinct seeding parameters.

13. The security domain for controlling PKI keys of claim 1, where a root certificate authority consent allows a transition between different security domains.
